(19) United States
(12) Patent Application Publication
(10) Pub. No.: US 2025/0322142 A1
(43) Pub. Date: Oct. 16, 2025

(54) ELECTRONIC SYSTEM AND METHOD FOR GENERATING TEST PAPER

(71) Applicant: Optoma Corporation, New Taipei City (TW)

(72) Inventor: Wei-Chung Wang, New Taipei City (TW)

(73) Assignee: Optoma Corporation, New Taipei City (TW)

(21) Appl. No.: 19/078,294

(22) Filed: Mar. 13, 2025

(30) Foreign Application Priority Data
Apr. 10, 2024 (TW) 113113241

(51) Int. Cl. G06F 40/103; G06F 3/0482; G06F 3/04847; G09B 7/00

(52) U.S. Cl. CPC G06F 40/103; G06F 3/0482; G06F 3/04847; G09B 7/00

(57) ABSTRACT

An electronic system and a method for generating a test paper are provided. The electronic system includes an electronic device. The electronic device includes an input device, a display device, a first storage medium, and a first processing device. The method includes: executing a generating test paper program and providing a graphical user interface; obtaining a user requirement according to a first user operation on the graphical user interface; generating the test paper according to the user requirement; and displaying a preview of the test paper.

### CROSS-REFERENCE TO RELATED APPLICATION

This application claims the priority benefit of Taiwan application serial no. 113113241, filed on Apr. 10, 2024. The entirety of the above-mentioned patent application is hereby incorporated by reference herein and made a part of this specification.

### BACKGROUND

### Technical Field

The disclosure relates to an electronic system and a display method, and particularly relates to an electronic system and a method for generating test paper.

### Description of Related Art

In the conventional method of preparing a test paper or an exam paper, teachers spend a lot of time thinking test questions corresponding to the test scope. Moreover, when designing the test paper, teachers must also consider the difficulty of the questions and the time required for students to answer the questions, as well as avoid including too many questions in previous tests, so that the test paper loses its function of distinguishing learning abilities of students. Therefore, how to generate the test paper more efficiently is one of the important issues in this education field.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the disclosure was acknowledged by a person of ordinary skill in the art.

### SUMMARY

The disclosure provides an electronic system and a method for generating a test paper, which can generate a corresponding test paper according to a user requirement obtained by a first user operation on a graphical user interface through an input device.

Other objectives and advantages of the disclosure may be further understood from the technical features disclosed in the disclosure.

To achieve one or part or all of the above objectives or other objectives, an electronic system for generating a test paper in an embodiment of the disclosure includes: an electronic devices, including: an input device, a display device, a first storage medium, and a first processing device. The display device provides a graphical user interface. The first storage medium stores a test paper generation program. The first processing device is electrically coupled to the first storage medium, the input device, and the display device, respectively. The first processing device executes the test paper generation program, and the first processing device obtains a user requirement according to a first user operation on the graphical user interface through the input device. By executing the test paper generation program, the first processing device obtains the test paper according to the user requirement, and the display device is configured to display a preview of the test paper.

In an embodiment of the disclosure, the user requirement includes at least one of a number of questions, at least one knowledge point, difficulty, types of question, or answering time.

In an embodiment of the disclosure, the first storage medium is configured to store a generative adversarial network module, and the generative adversarial network module generates the test paper.

In an embodiment of the disclosure, the graphical user interface provides multiple options, and the first processing device is configured to select the at least one knowledge point from the options according to the first user operation.

In an embodiment of the disclosure, the graphical user interface provides a slider, and the first processing device obtains the number of questions, the difficulty, or the types of question according to the first user operation on the slider.

In an embodiment of the disclosure, the input device receives a user command, and the first processing device determines whether the test paper is usable according to the user command. In response to determining that the test paper is not usable, the input device receives a second user operation on the graphical user interface to obtain a user preference, and the first processing device generates a new test paper by the generative adversarial network module according to the user preference.

In an embodiment of the disclosure, the user preference includes at least one of at least one knowledge point, a number of questions corresponding to the at least one knowledge point, difficulty, or a number of questions corresponding to the difficulty.

In an embodiment of the disclosure, the first processing device provides a bar chart through the graphical user interface, and the first processing device obtains at least one knowledge point and a number of questions corresponding to the at least one knowledge point according to the second user operation on the bar chart.

In an embodiment of the disclosure, the first processing device provides a pie chart through the graphical user interface, and the first processing device obtains difficulty and a number of questions corresponding to the difficulty according to the second user operation on the pie chart.

In an embodiment of the disclosure, the first processing device is configured to receive questions, and provide the options corresponding to the questions through the graphical user interface. The input device receives a third user operation on the graphical user interface, and the first processing device is configured to select labels from the options according to the third user operation. The first processing device generates training data according to the questions and the labels.

In an embodiment of the disclosure, the first processing device receives a file including the questions, and provides the options corresponding to the file through the graphical user interface. The input device receives a third user operation corresponding to the graphical user interface, and the first processing device selects the labels from the options according to the third user operation. The first processing device generates pieces of training data according to the questions and the labels.

In an embodiment of the disclosure, the electronic systems further includes a cloud server. The cloud server is communicatively connected to the electronic devices through a network, and the cloud server further includes a second processing device and a second storage medium.

In an embodiment of the disclosure, the user requirement includes at least one of a number of questions, at least one knowledge point, difficulty, types of question, or answering time.

In an embodiment of the disclosure, the second storage medium is configured to store a generative adversarial network module, and the generative adversarial network module generates the test paper.

In an embodiment of the disclosure, the graphical user interface provides the options, and the second processing device selects the at least one knowledge point from the options according to the first user operation.

In an embodiment of the disclosure, the graphical user interface provides a slider, and the second processing device obtains the number of questions, the difficulty, or the types of question according to the first user operation on the slider.

In an embodiment of the disclosure, the input device receives a user command, and the second processing device is configured to determine whether the test paper is usable according to the user command. In response to determining that the test paper is not usable, the input device is configured to receive the second user operation on the graphical user interface to obtain a user preference, and the second processing device generates a new test paper by the generative adversarial network module according to the user preference.

In an embodiment of the disclosure, the user preference includes at least one of at least one knowledge point, a number of questions corresponding to the at least one knowledge point, difficulty, or a number of questions corresponding to the difficulty.

In an embodiment of the disclosure, the second processing device provides a bar chart through the graphical user interface, and the second processing device obtains at least one knowledge point and a number of questions corresponding to the at least one knowledge point according to the second user operation on the bar chart.

In an embodiment of the disclosure, the second processing device provides a pie chart through the graphical user interface, and the second processing device obtains difficulty and a number of questions corresponding to the difficulty according to the second user operation on the pie chart.

In an embodiment of the disclosure, the second processing device receives questions, provides the options corresponding to the questions through the graphical user interface, and receives a third user operation on the graphical user interface through the input device. The second processing device selects labels from the options according to the third user operation, and generates training data according to the questions and labels.

In an embodiment of the disclosure, the second processing device receives a file including the questions, and provides the options corresponding to the file through the graphical user interface. The input device receives a third user operation corresponding to the graphical user interface, and the second processing device selects labels from the options according to the third user operation. The second processing device generates the pieces of training data according to the questions and the labels.

To achieve one or part or all of the above purposes or other purposes, a method for generating a test paper in an embodiment of the disclosure includes: executing a test paper generation program by a first processing device; displaying a graphical user interface by a display device; obtaining a user requirement according to a first user operation on the graphical user interface by an input device; obtaining the test paper according to the user requirement by the first processing device; and displaying a preview of the test paper by the display device. Based on the above, the electronic system of the disclosure provides the graphical user interface to the user. The user may operate on the graphical user interface to instruct the electronic system to generate the test paper that meets the user requirement.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

FIG. 1A illustrates a block diagram of an electronic system configured to generate a test paper according to an embodiment of the disclosure.

FIG. 1B illustrates a block diagram of an electronic system configured to generate a test paper according to another embodiment of the disclosure.

FIG. 2 illustrates a schematic diagram of a graphical user interface configured to generate training data according to an embodiment of the disclosure.

FIG. 3 illustrates a schematic diagram of a graphical user interface configured to generate training data according to an embodiment of the disclosure.

FIG. 4 illustrates a schematic diagram of training a generative adversarial network module according to an embodiment of the disclosure.

FIG. 5 illustrates a flowchart of generating a test paper according to an embodiment of the disclosure.

FIG. 6 illustrates a schematic diagram of a graphical user interface configured to receive a user requirement according to an embodiment of the disclosure.

FIG. 7A illustrates a bar chart showing a distribution relationship between a number of questions and knowledge points according to an embodiment of the disclosure.

FIG. 7B illustrates a pie chart showing a distribution relationship between a number of questions and difficulty according to an embodiment of the disclosure.

FIG. 8 illustrates a schematic diagram of displaying a preview of test paper in a graphical user interface according to an embodiment of the disclosure.

FIG. 9A and FIG. 9B illustrate schematic diagrams of graphical user interfaces configured to indicate a positive reward or a negative reward according to an embodiment of the disclosure.

FIG. 10 illustrates a schematic diagram of a graphical user interface configured to fine-tune weight parameters according to an embodiment of the disclosure.

FIG. 11 illustrates a flowchart of a method for generating a test paper according to an embodiment of the disclosure.

### DESCRIPTION OF THE EMBODIMENTS

It is to be understood that other embodiment may be utilized and structural changes may be made without departing from the scope of the disclosure. Also, it is to be understood that the phraseology and terminology used herein are for the purpose of description and should not be regarded as limiting. The use of “including”, “comprising”, or “having” and variations thereof herein is meant to encompass the items listed thereafter and equivalents thereof as well as additional items. Unless limited otherwise, the terms “connected”, “coupled”, and “mounted”, and variations thereof herein are used broadly and encompass direct and indirect connections, couplings, and mountings.

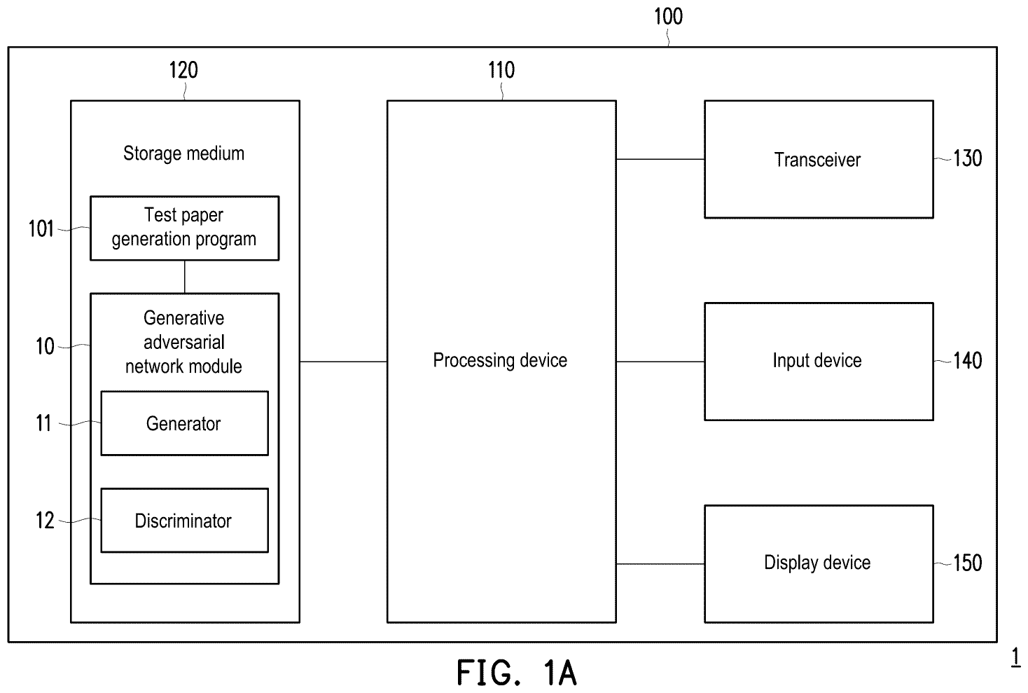

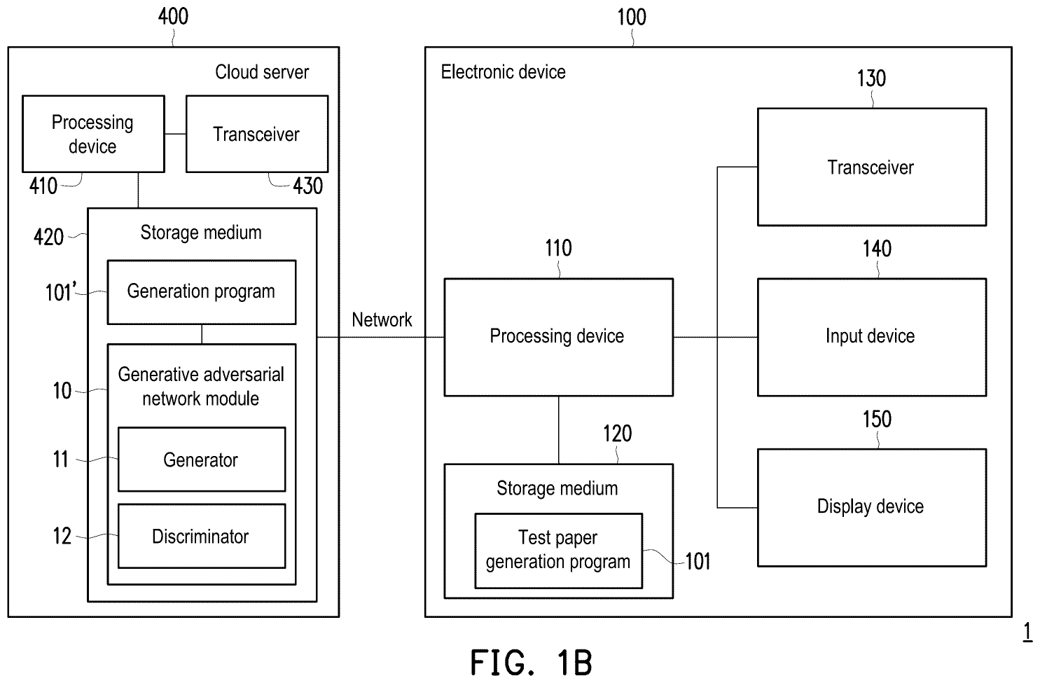

FIG. 1A illustrates a block diagram of an electronic system configured to generate a test paper according to an embodiment of the disclosure. An electronic system 1 includes an electronic device 100 which may include a processing device 110, a storage medium 120, a transceiver 130, an input device 140, and a display device 150.

The processing device 110 may include at least one processor. The processor may be, for example, a central processing unit (CPU), or a micro control unit (MCU) for a common purpose or a specific purpose, a microprocessor, a digital signal processor (DSP), a programmable controller, an application specific integrated circuit (ASIC), a graphics processing unit (GPU), an image signal processor (ISP), an image processing unit (IPU), an arithmetic logic unit (ALU), a complex programmable logic device (CPLD), a field programmable gate array (FPGA), or other similar elements or a combination of the aforementioned elements. The processing device 110 may be electrically connected to the storage medium 120, the transceiver 130, the input device 140, and the display device 150, respectively, and may access and execute algorithms, multiple modules, and various programs stored in the storage medium 120. Electrical connection is defined as a connection capable of transmitting electrical signals. A module is defined as including at least one program or including at least one algorithm.

The storage medium 120 may be, for example, any type of a fixed or removable random access memory (RAM), read-only memory (ROM), flash memory, hard disk drive (HDD), solid state drive (SSD), similar elements, or a combination of the aforementioned elements. The storage medium 120 is configured to store algorithms, modules, or programs which may be executed by the processing device 110. In this embodiment, the storage medium 120 may store a test paper generation program 101 and a generative adversarial network module (GAN module) 10 with a generator 11 and a discriminator 12, the functions of which is described later. The generator 11, the discriminator 12, and the GAN module 10 all include at least one program or at least one algorithm.

The transceiver 130 transmits or receives signals wirelessly or by wire. The transceiver 130 may be, for example, a wireless network circuit or chip, a wired network circuit or chip, or a combination of the aforementioned circuits or chips. In an embodiment, the transceiver 130 may be a circuit or chip supporting global system for mobile communication (GSM), a circuit or chip for wireless fidelity (WiFi), or a circuit or chip for bluetooth communication technology, or a combination thereof, but is not limited to thereto. In addition, the transceiver 130 may also perform operations such as low noise amplification, impedance matching, frequency mixing, up or down frequency conversion, filtering, or amplification. The transceiver 130 is configured to connect to Internet.

The input device 140 may be operated by the user to generate a user command, and transmit the user command to the processing device 110. The input device 140 may include, but is not limited to, devices such as a keyboard, a mouse, or a touch screen.

The display device 150 may include a liquid-crystal display (LCD), a light-emitting diode (LED) display, a vacuum fluorescent display (VFD), a plasma display panel (PDP), an organic light-emitting diode (OLED), or a field-emission display (FED). The processing device 110 configured to execute the test paper generation program 101 may provide a graphical user interface (GUI) for the user through the display device 150. The user may interact with the electronic device 100 by operating the GUI through the input device 140. Furthermore, the processing device 110 configured to execute the test paper generation program 101 to implement the GAN module 10 may provide the GUI for the user through the display device 150.

The processing device 110 may train the GAN module 10 based on the generative adversarial network algorithm according to training data. The GAN module 10 includes the generative adversarial network algorithm. The training data may include questions and labels corresponding to the questions, where the labels may include but are not limited to grades, semesters, subjects, difficulty, time (that is, answering time), types of question, or knowledge points. For example, the types of question may include a multiple choice question, an essay question, or a fill in the blank question.

The processing device 110 may access the network through the transceiver 130 to collect questions (for example, previous exam questions) as training data. For example, the processing device 110 may perform web crawling on the network to collect questions, or the user may input questions manually. Subsequently, the user may manually label the questions as training data.

In an embodiment, the processing device 110 may receive a file including one or more questions through the transceiver 130, and may display the GUI through the display device 150, where the GUI may include multiple options corresponding to the file. The processing device 110 may receive a user operation on the GUI through the input device 140, and select at least one label corresponding to the file from the options according to the user operation. The processing device 110 may generate one or more pieces of the training data according to the file and the at least one label selected by the user, and provide the training data to the GAN module 10.

FIG. 1B illustrates a block diagram of an electronic system configured to generate a test paper according to another embodiment of the disclosure. The electronic system 1 further includes a cloud server 400. The cloud server 400 is communicatively connected to the electronic device 100 through a network. The cloud server 400 may include a processing device 410, a storage medium 420, and a transceiver 430. The processing device 410 may be electrically connected to the storage medium 420 and the transceiver 430 respectively, and may access and execute multiple modules and various programs stored in the storage medium 420. The hardware devices of the processing device 410, the storage medium 420, and the transceiver 430 are related devices to the hardware devices of the processing device 110, the storage medium 120, and the transceiver 130 of the aforementioned electronic device 100, which is not described again.

It is worth mentioning that the difference between the example in FIG. 1B and the example in FIG. 1A lies in that: in the embodiment of FIG. 1B, the GAN module 10 with the generator 11 and the discriminator 12 is stored in the storage medium 420 of the cloud server 400. The processing device 410 (a second processing device) may train the GAN module 10 according to the training data. The storage medium 420 further has a generation program 101′. In detail, the user may operate the GUI through the input device 140 of the electronic device 100, the processing device 110 (a first processing device) of the electronic device 100 executes the test paper generation program 101, the processing device 110 generates a need signal, and the transceiver 130 transmits the need signal to the transceiver 430 of the cloud server 400 through the network. According to the need signal, the processing device 410 of the cloud server 400 is configured to execute the generation program 101′ to implement the GAN module 10. When the GAN module 10 generates a test paper, the transceiver 430 transmits a signal corresponding to the test paper to the transceiver 130 of the electronic device 100 through the network. By means of the processing device 110 executing the test paper generation program 101, the first processing device 110 is configured to obtain the test paper according to the need of the user, and the processing device 110 controls the display device 150 of the electronic device 100 to display a preview of the test paper.

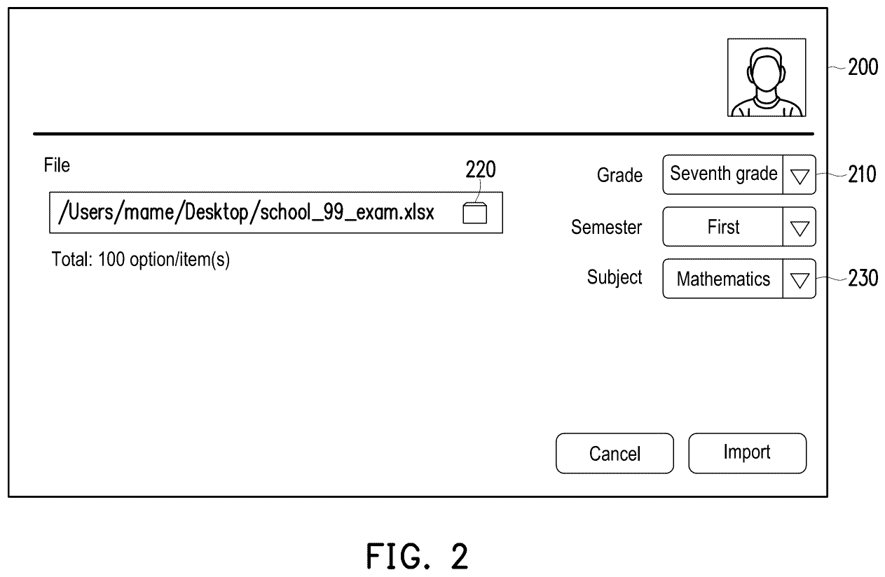

FIG. 2 illustrates a schematic diagram of a GUI 200 configured to generate training data according to an embodiment of the disclosure. The processing device 110 obtains a file including one or more questions through the transceiver 130. The user may operate a button 220 of the GUI 200 through the input device 140 to select a file of the electronic device 100, that is, to transfer the file to the GAN module 10 for training in a batch manner. In another aspect, the user may operate the drop-down menus of the GUI 200 to select at least one label corresponding to the file. For example, the user may select “Seventh grade” from a drop-down menu 210 as the label for the file. Accordingly, each piece of the training data generated according to the settings in FIG. 2 may include the label “Seventh grade”, and so on. Finally, the file with the completed label is imported into the GAN module 10.

It is assumed that the file collected by the processing device 110 already includes a label to become the label in the training data. For example, if the file collected by the processing device 110 includes a label “Mathematics”, then a default value of a drop-down menu 230 corresponding to “Subject” provided by the GUI 200 may be “Mathematics”, where “Mathematics” is the label in the training data.

In an embodiment, taking the electronic system 1 of FIG. 1A as an example, the processing device 110 may receive questions through the transceiver 130, and may display the GUI through the display device 150, where the GUI may include options corresponding to the questions. The processing device 110 may receive a user operation on the GUI through the input device 140, and select a label corresponding to the question from the options according to the user operation. The processing device 110 may generate training data based on the question and the label selected by the user and provide the training data to the GAN module 10.

In an embodiment, taking the electronic system 1 of FIG. 1B as an example, the processing device 110 may receive questions through the transceiver 130, and may display the GUI through the display device 150, where the GUI may include options corresponding to the questions. The processing device 110 may receive a user operation on the GUI through the input device 140, and select a label corresponding to the question from the options according to the user operation. The aforementioned question and the label corresponding to the question (the training data) are transmitted to the processing device 410 of the cloud server 400. The processing device 410 may provide the training data (the question and the label selected by the user) to the GAN module 10 for training.

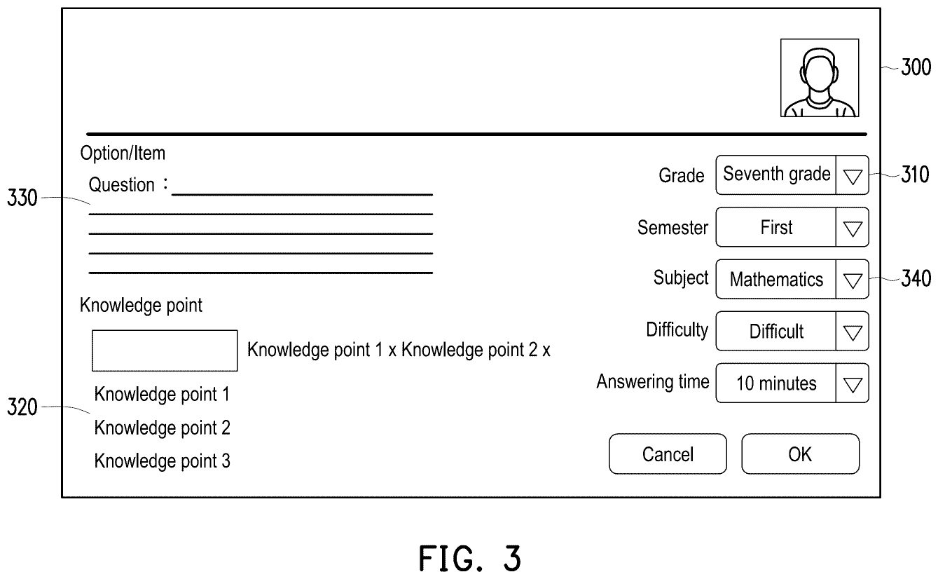

FIG. 3 illustrates a schematic diagram of a GUI 300 configured to generate training data according to an embodiment of the disclosure. The GUI 300 may display the content of a single question an area 330. The user may operate an option 320 of the GUI 300 through the input device 140 to select one or more “Knowledge points” corresponding to the question. For example, the user may select “Knowledge point 1” or “Knowledge point 2” or both “Knowledge point 1” and “Knowledge point 2” as a label for the question. In another aspect, the user may operate the drop-down menus of the GUI 300 to select a label corresponding to the question. For example, the user may select “Seventh grade” corresponding to the question from a drop-down menu 310 as a label for the question. Accordingly, the training data generated according to the settings in FIG. 3 may include the label “Seventh grade”. In addition, a default value of a drop-down menu 340 corresponding to “Subject” provided by the GUI 300 may be “Mathematics” as the label for the question. The GUI 300 is configured to generate a single question as training data.

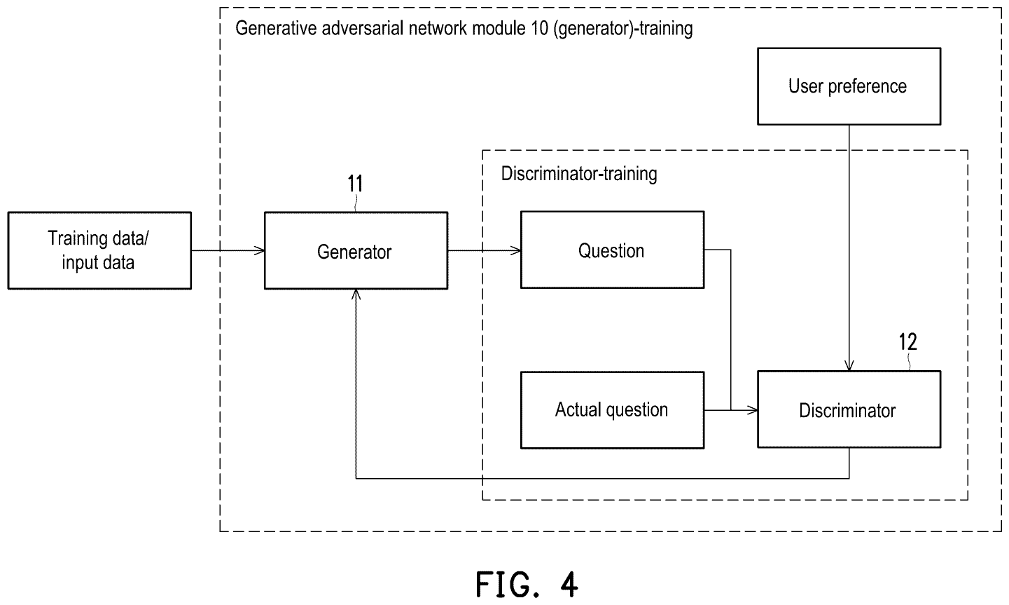

FIG. 4 illustrates a schematic diagram of training a generative adversarial network module according to an embodiment of the disclosure. The processing device 110 in FIG. 1A may train the GAN module 10 based on the generative adversarial network algorithm according to the input training data. Moreover, the generator 11 of the GAN module 10 is trained according to the input training data. In FIG. 1B, the processing device 410 may train the GAN module 10 based on the generative adversarial network algorithm according to the input training data. Furthermore, the generator 11 of the GAN module 10 is trained according to the input training data. The generator 11 may generate questions according to the input training data. The discriminator 12 may determine the difference between the questions generated by the generator 11 and the actual questions, and then determine whether the questions generated by the generator 11 are genuine. The actual questions are confirmed complete, and correct questions are regarded as the standard. The processing device 110 or the processing device 410 may increase the similarity between the questions generated by the generator 11 and the actual questions based on the generative adversarial network algorithm, thereby training the generator 11. If a reward function value calculated by the discriminator 12 according to the questions generated by the generator 11 is less than a preset value, it is shown that the questions generated by the generator 11 are not realistic enough (for example, grammatical errors appear in the questions). Accordingly, the processing device 110 or the processing device 410 may further train or update the generator 11. In another aspect, the processing device 110 or the processing device 410 may improve the ability of the discriminator 12 to determine whether the input data is an actual question based on the generative adversarial network algorithm, thereby training the discriminator 12. If the discriminator 12 may not effectively identify the difference between the questions generated by the generator 11 and the actual questions, it is shown that the discrimination ability of the discriminator 12 is weak. Accordingly, the processing device 110 may further train or update the discriminator 12. In addition, a user preference may be input to the discriminator 12 as training data. The user preference may include data such as the difficulty of the questions and the number of questions corresponding to the difficulty.

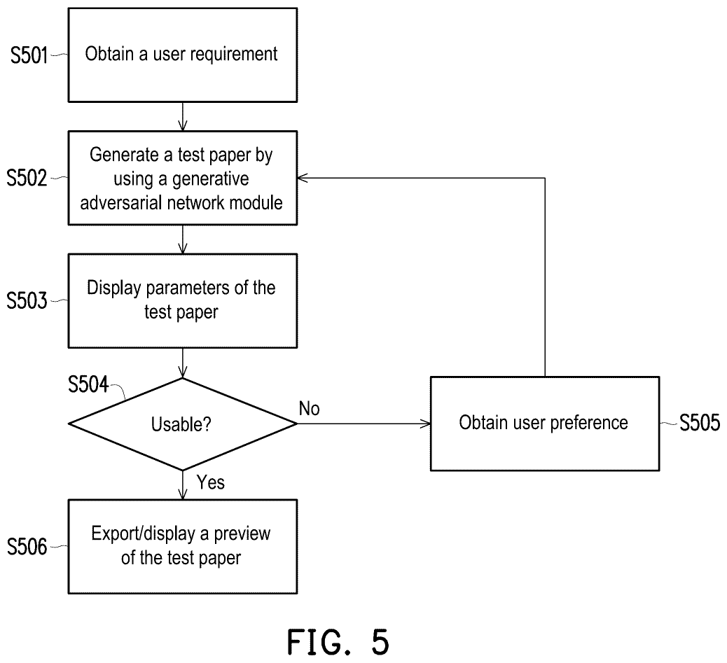

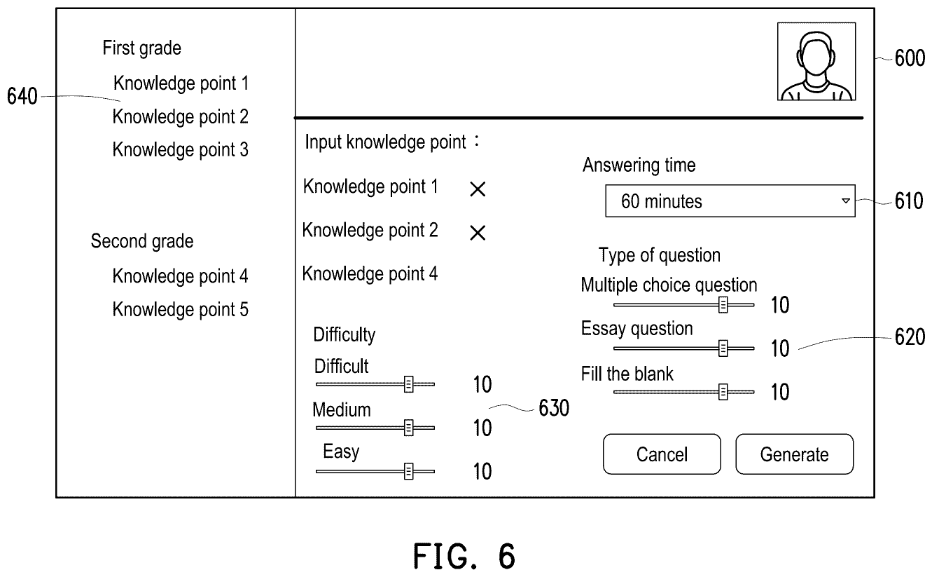

FIG. 5 illustrates a flowchart of generating a test paper according to an embodiment of the disclosure. FIG. 6 illustrates a schematic diagram of a GUI 600 configured to receive a user requirement according to an embodiment of the disclosure. Please refer to FIG. 5 and FIG. 6, where the process in FIG. 5 may be implemented by the electronic device 100 of the electronic system 1 shown in FIG. 1A or the electronic system 1 shown in FIG. 1B. In Step S501, the processing device 110 or the processing device 410 may obtain a user requirement. Specifically, the processing device 110 in FIG. 1A may receive a user operation on the GUI through the input device 140, thereby obtaining the user requirement. The user requirement may include but may not be limited to the number of questions, knowledge points, difficulty, types of question, or answering time. In an embodiment, the processing device 410 in FIG. 1B receives the user requirement provided by the electronic device 100.

FIG. 6 illustrates a schematic diagram of a GUI 600 configured to receive a user requirement according to an embodiment of the disclosure. According to Step S501, the GUI 600 displays the options. The GUI 600 may provide the user with the options corresponding to different “grades” for the user to select. The processing device 110 or the processing device 410 may select knowledge points corresponding to all questions in the test paper from the aforementioned options based on the user operation (the operation operated by the user through the input device 140). For example, multiple options 640 provided by the GUI 600 may include “Knowledge point 1”, “Knowledge point 2”, and “Knowledge point 3” corresponding to “First grade”, and “Knowledge point 4” and “Knowledge point 5” corresponding to “Second grade”. The processing device 110 may select “Knowledge point 1”, “Knowledge point 2”, and “Knowledge point 4” based on the user operation to ensure that the questions in the test paper generated by the electronic system 1 posses “Knowledge point 1”, “Knowledge point 2”, and “Knowledge point 4”.

The GUI 600 may provide the user with the options corresponding to “answering time” for the user to select. The processing device 110 or the processing device 410 may select the answering time for completing the entire test paper from the options based on the user operation. For example, a drop-down menu 610 provided by the GUI 600 may include the options corresponding to various time sections respectively. The processing device 110 or the processing device 410 may select “60 minutes” based on the user operation, to ensure that the sum of answering time for all questions in the test paper generated by the electronic system 1 is equal to or close to “60 minutes”.

The GUI 600 may provide the user with a slider for adjustment. The processing device 110 or the processing device 410 may obtain the user requirement including the number of questions, difficulty, or types of question based on the slider operated by the user. For example, the GUI 600 may provide the user with a slider 620 corresponding to the types of question. For instance, the processing device 110 or the processing device 410 may adjust the slider 620 based on the user operation, to ensure that the test paper generated by the electronic system 1 includes 10 multiple choice questions, 10 essay questions, and 10 fill in the blank questions. For another example, the GUI 600 may provide the user with a slider 630 corresponding to the number of questions. The processing device 110 or the processing device 410 may adjust the slider 630 based on the user operation, to ensure that the test paper generated by the electronic system 1 includes 10 difficult questions, 10 medium questions, and 10 easy questions.

Returning to FIG. 5, in Step S502, the processing device 110 or the processing device 410 may generate the test paper by using the GAN module 10 according to the user requirement. Further, the processing device 110 or the processing device 410 may use the GAN module 10 to generate one or more questions based on the user requirement, and then combine the generated questions into the test paper. For example, the user requirement may include “Number of questions: 30”, “Knowledge point 1”, “Knowledge point 2”, “Knowledge point 4”, “Difficult: 10 questions”, “Medium: 10 questions”, “Easy: 10 questions”, “Multiple choice questions: 10 questions”, “Essay questions: 10 questions”, “Fill in the blank questions: 10 questions”, and “Answering time: 60 minutes”, as shown in FIG. 6. The processing device 110 or the processing device 410 may generate multiple pieces of input data, where the number of input data is the same as the “Number of questions (30)”. The processing device 110 or the processing device 410 may input 30 pieces of the input data into the GAN module 10 respectively to generate 30 questions (as shown in FIG. 4), and combine the 30 questions into the test paper. Among the 30 pieces of the input data, 10 pieces include information related to “Difficult”, another 10 pieces include information related to “Medium”, and the remaining 10 pieces include information related to “Easy”. In another aspect, among the 30 pieces of the input data, 10 pieces include information related to “Multiple choice questions”, another 10 pieces include information related to “Essay questions”, and the remaining 10 pieces include information related to “Fill in the blank questions”. Each of the 30 pieces of the input data includes information related to “Knowledge point 1”, “Knowledge point 2”, or “Knowledge point 4”. Each of the 30 pieces of the input data includes information related to “Answering time”, and the sum of “Answering time” included in the 30 pieces of the input data is “60 minutes”. For example, the processing device 110 or the processing device 410 may divide “Answering time (60 minutes)” by “Number of questions (30)” to obtain “2 minutes”. The processing device 110 or the processing device 410 may add information related to “2 minutes” to each piece of the input data, so that the test paper generated by the electronic system 1 includes 30 questions, and the answering time required for each question is 2 minutes.

In an embodiment, how the GAN module 10 is trained and how the GAN module 10 is configured to generate the test paper are described as follows. The GAN module 10 may include a sequential GAN (seqGAN). The seqGAN may decompose a problem of previous exam to obtain one or more tokens, where a token is the smallest unit in the content of the previous exam. The token may include, for example, a word, a sub word, or a character. The use of the token allows the seqGAN to process and understand the rich diversity of natural language, thereby generating corresponding content. For example, the seqGAN may decompose the content of previous exam into multiple tokens, as shown in Table 1.

TABLE 1
Please list important historical events of the Three Kingdoms period
in Chinese history.
↓
Please/list/important historical events/of/the Three Kingdoms period
Please explain the feudal system of ancient China
↓
Please/explain/the feudal system/of/ancient China

The seqGAN may generate questions by performing question reconstruction on the previous exam through the following methods. (1) Vocabulary replacement: the tokens representing keywords or phrases in the problem are replaced to create a new problem with similar meanings to the original problem in the previous exam. (2) Structure adjustment: the structure of the problem is adjusted, for example, changing an interrogative sentence to a declarative sentence, altering a sentence pattern, or rearranging the order of the sentence. (3) Problem combination: different parts of the generated problem are combined to create a complete problem with new meanings. (4) Knowledge point/keyword guidance: the problem corresponding to the specific range is generated based on the knowledge points/keywords. For example, the seqGAN may generate a new problem “List important historical events of the Three Kingdoms period.” by using the vocabulary replacement based on the problem in Table 1, generate a new problem “Can you mention important historical events of the Three Kingdoms period?” by using the structure adjustment based on the problem in Table 1, generate a new problem “Explain the feudal system in ancient China, and list important historical events of the Three Kingdoms period.” by using the problem combination based on the problem in Table 1, or generate a new problem “Which of the following battles is considered an important land and sea battle of the Three Kingdoms period?(a) Battle of Guandu (b) Battle of Red Cliffs (c) Battle of Huarong Road (d) Battle of Jiayi” by using the knowledge point “land and sea battles” based on the problem in Table 1.

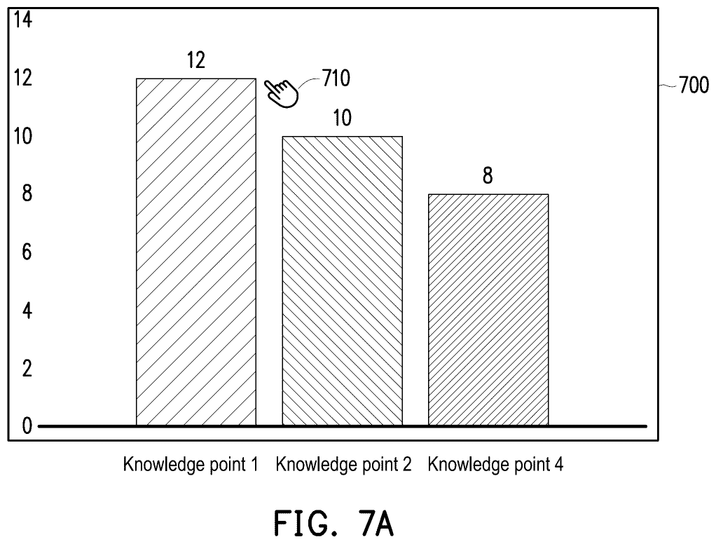

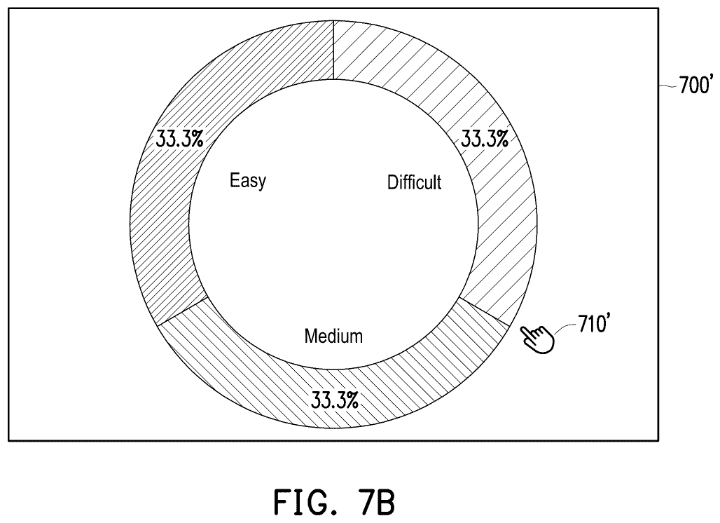

In Step S503, the processing device 110 or the processing device 410 may obtain parameters of the test paper from the GAN module 10, and display the parameters of the test paper through the display device 150 for user reference. The parameters of the test paper may include, but may not be limited to, the number of questions, the distribution relationship between the number of questions and knowledge points, or the distribution relationship between the number of questions and difficulty. In an embodiment, the parameters of the test paper displayed by the display device 150 are, for example, stored in the storage medium 120 or the storage medium 420, and the parameters of the test paper include the distribution relationship between the number of questions and knowledge points or the distribution relationship between the number of questions and difficulty. The processing device 110 or the processing device 410 may generate input data according to the parameters of the test paper. For example, the processing device 110 or the processing device 410 may generate 12 input data corresponding to “Knowledge point 1”, 10 input data corresponding to “Knowledge point 2”, and 8 input data corresponding to “Knowledge point 4” based on the settings shown in FIG. 6 and the parameters of the test paper (the number of questions and the knowledge points), and then generate 30 questions based on the aforementioned 30 input data, where the distribution relationship between the number of questions and the knowledge points is shown in FIG. 7A.

In an embodiment, the processing device 110 or the processing device 410 may generate 10 input data corresponding to “Easy”, 10 input data corresponding to “Medium”, and 10 input data corresponding to “Difficult” based on the settings shown in FIG. 6 and the parameters of the test paper (the number of questions and difficulty), and then generate 30 questions based on the aforementioned 30 input data, where the distribution relationship between the number of questions and difficulty is shown in FIG. 7B.

In Step S504, the processing device 110 or the processing device 410 may determine whether the test paper generated by the GAN module 10 is usable. Specifically, the processing device 110 may receive a user command through the input device 140, and determine whether the test paper is usable according to the user command. If the user considers the test paper usable, the user may input a user command to indicate that the test paper is usable. If the user considers the test paper unusable, the user may input a user command to indicate that the test paper is unusable. If the processing device 110 or the processing device 410 determines that the test paper is usable, then Step S506 is proceeded, where the processing device 110 or the processing device 410 provides the test paper and displays a preview of the test paper through the display device 150. If the processing device 110 or the processing device 410 determines that the test paper is unusable, then Step S505 is proceeded.

In Step S505, the user may provide an adjustment to the parameters of the test paper displayed through the display device 150. Further, the processing device 110 or the processing device 410 may receive a user operation on the GUI through the input device 140 to obtain a user preference, where the user preference may include, but may not be limited to, adjustments to knowledge points, the number of questions corresponding to the knowledge points, difficulty, or the number of questions corresponding to the difficulty. The processing device 110 may store the user preference in the storage medium 120 or the storage medium 420.

In an embodiment, the processing device 110 or the processing device 410 may generate a user preference by adjusting a bar chart displayed on the GUI according to the user operation. FIG. 7A illustrates a bar chart showing a distribution relationship between a number of questions and knowledge points according to an embodiment of the disclosure, where the distribution relationship between the number of questions (the vertical axis) and the knowledge points (the horizontal axis) may be obtained from the parameters of the test paper. A GUI 700 may display the bar chart representing the distribution relationship between the number of questions and the knowledge points as reference and adjustment for the user. The user may adjust the bars in the bar chart to modify the distribution relationship between the number of questions and the knowledge points. For example, the user may operate a cursor 710 through the input device 140 to drag the bar representing “12 questions corresponding to knowledge point 1”, thereby adjusting the number of questions corresponding to knowledge point 1 and generating a user preference. The generated user preference may include adjustments to the knowledge points and the number of questions corresponding to the knowledge points.

In an embodiment, the processing device 110 or the processing device 410 may generate a user preference by adjusting a pie chart displayed on the GUI according to the user operation. FIG. 7B illustrates a pie chart showing a distribution relationship between a number of questions and difficulty according to an embodiment of the disclosure, where the distribution relationship between the number of questions and the difficulty may be obtained from the parameters of the test paper. A GUI 700′ may display the pie chart representing the distribution relationship between the number of questions and the difficulty as reference for the user. The user may adjust sections of the pie chart to modify the distribution relationship between the number of questions and the difficulty. For example, the user may operate a cursor 710′ through the input device 140 to drag the section representing “difficult questions account for 33.3% of the test paper”, thereby adjusting the number of questions corresponding to the difficult level and generating a user preference. The generated user preference may include adjustments to the difficulty and the number of questions corresponding to the difficult level.

After obtaining the user preference, the processing device 110 or the processing device 410 may execute Step S502 according to the user preference. Specifically, referring to FIG. 4 again, the processing device 110 or the processing device 410 may generate one or more input data corresponding to the user preference, and input the one or more input data into the GAN module 10 to generate a new test paper.

In an embodiment, the processing device 110 or the processing device 410 may update the discriminator 12 according to one or more user preference stored in the storage medium 120 or the storage medium 4200, and then update the generator 11 according to the updated discriminator 12, to train the GAN module 10. Referring to FIG. 4, the processing device 110 or the processing device 410 may update the discriminator 12 according to the user preference based on a reinforcement learning (RL) algorithm. Specifically, the processing device 110 or the processing device 410 may calculate the reward function value of the RL algorithm according to the user preference, and update the discriminator 12 according to the reward function value. After the discriminator 12 is updated based on the RL algorithm, the processing device 110 or the processing device 410 may retrain or update the generator 11 and the discriminator 12 by the generative adversarial network algorithm according to the updated discriminator 12.

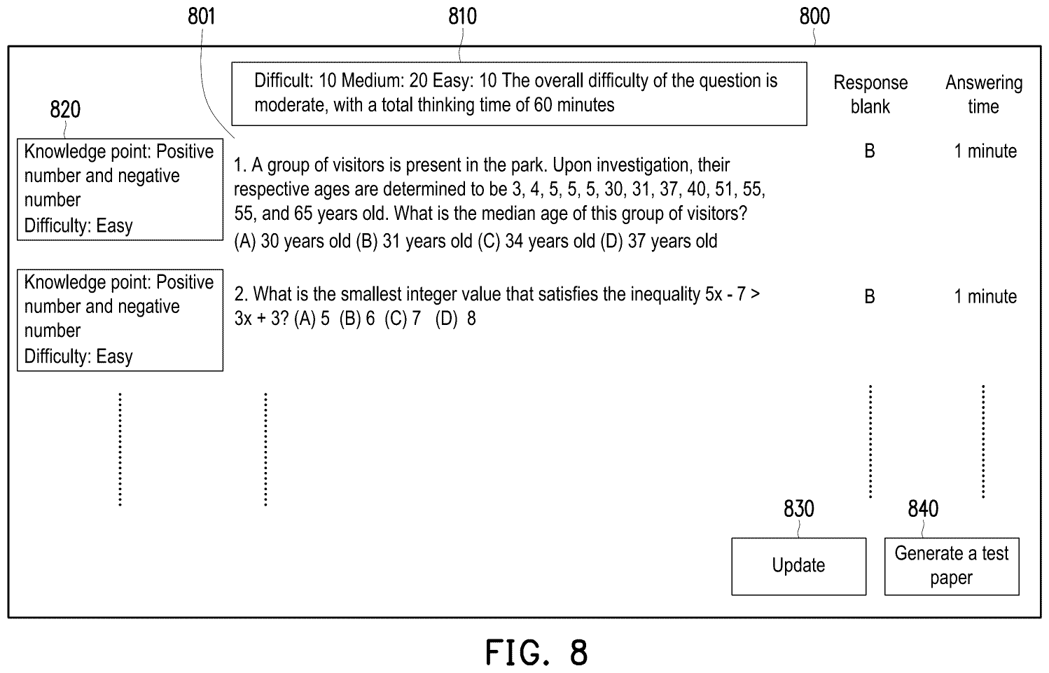

Returning to Step S506, the processing device 110 or the processing device 410 provides the test paper generated by the GAN module 10, and displays the preview of the test paper through the display device 150. Referring to FIG. 8, FIG. 8 illustrates a schematic diagram of displaying a preview of test paper in a GUI according to an embodiment of the disclosure. The display device 150 displays the preview of the test paper in the GUI 800. The preview of the test paper includes a content 801 of at least one question, a user requirement 810, a knowledge point 820 corresponding to the question, an update button 830, a test paper generation button 840, a response blank, and answering time corresponding to the question. It is worth mentioning that when there are incorrect words or descriptions in the content 801 of the question, the user may adjust (delete or add) the content 801 of the question through the operation of the input device 140 and press the update button 830 to complete the adjustment of updating the content 801 of the question in the preview of the test paper. Afterwards, the user presses the test paper generation button 840 to output the test paper through an output device (not shown) communicatively connected to the electronic device 100. The output device, for example, may be a printer.

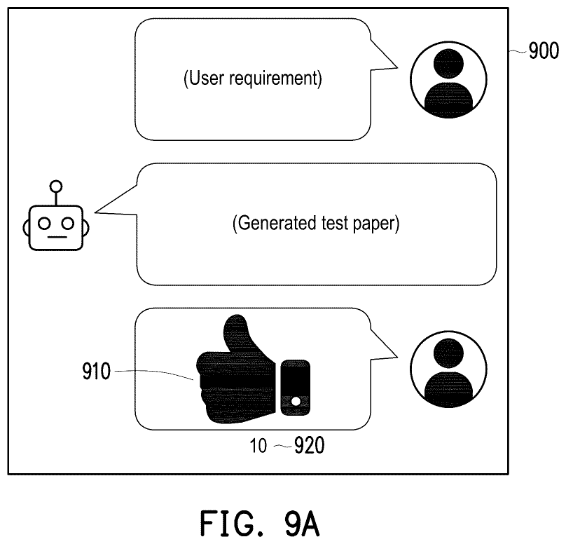

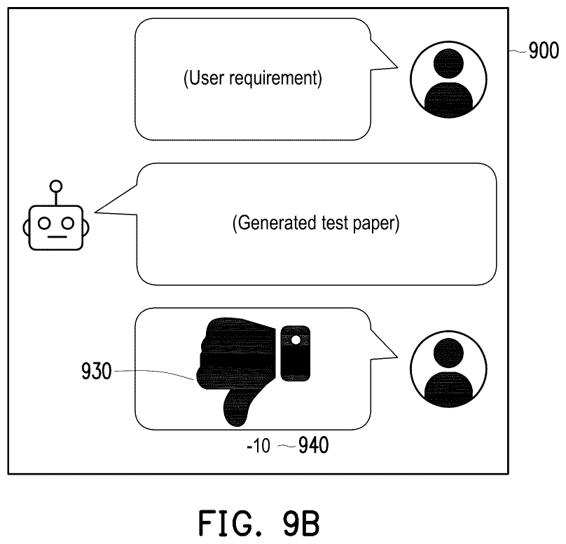

In addition, in an embodiment, during the training of the GAN module 10, after calculating the reward function value of the RL algorithm according to the user preference, the processing device 110 or the processing device 410 may display the reward function value through the GUI for the user reference. Taking FIG. 9A as an example, if the reward function value is “+10”, a GUI 900 may display a symbol 910 representing a positive reward and a value 920 with “+10”. Taking FIG. 9B as an example, if the reward function value is “−10”, the GUI 900 may display a symbol 930 representing a negative reward and a value 940 with “−10”.

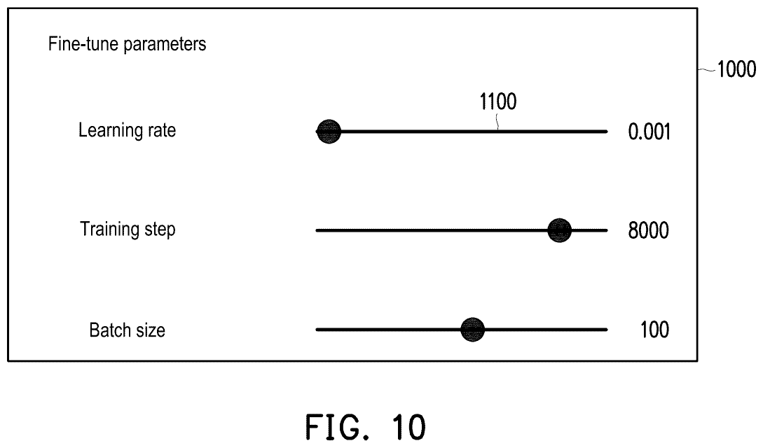

In an embodiment, the electronic system 1 may provide a GUI for the user to fine-tune the weight parameters of the GAN module 10. FIG. 10 illustrates a schematic diagram of a GUI 1000 configured to fine-tune weight parameters according to an embodiment of the disclosure. The GUI 1000 may provide sliders corresponding to the weight parameters. The user or the expert may operate the sliders through the input device 140 of the electronic system 1 to adjust the weight parameters. For example, the processing device 110 may adjust a slider 1100 according to the user operation from the input device 140 to adjust the learning rate of the GAN module 10. The processing device 110 may train the GAN module 10 according to the updated learning rate.

The weight parameters of the GAN module 10 may include, but may not be limited to, a learning rate, a training step, or a batch size. The larger the value of the learning rate, the greater the difference in a pattern of setting questions between the updated GAN module 10 and the pre-update GAN module 10. The training step is configured to specify the number of times the GAN module 10 transitions from an initial training state to training for a specific task. The more training steps, the higher the level of understanding of knowledge points by the GAN module 10. The batch size determines the amount of training data used when updating the GAN module 10. The larger the batch size, the better the GAN module 10 understands the knowledge points or types of question variations required by the user.

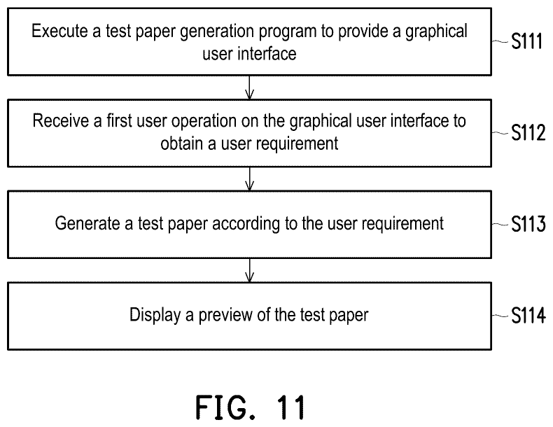

FIG. 11 illustrates a flowchart of a method for generating test a paper according to an embodiment of the disclosure, where the method may be implemented by the electronic system 1 as shown in FIG. 1A or the electronic system 1 as shown in FIG. 1B. In Step S111, the test paper generation program is executed to provide the GUI. In Step S112, the user requirement is obtained by the input device according to a first user operation on the GUI. In Step S113, the test paper is generated according to the user requirement. In Step S114, the preview of the test paper is displayed. In addition, the questions of the test paper are adjusted through user operation control of the electronic device 100 by the input device 140.

In summary, the technical means of this disclosure aim to solve the technical problem of how to generate the test paper with at least one question based on a large amount of labeled training data. The at least one question is different from at least one question in the training data, and how to allow the user to easily and intuitively adjust the content of the question and the user preference in the preview of the test paper through the input device in the GUI displayed on the display device. The user preference may include, but may not be limited to, adjustments to knowledge points, the number of questions corresponding to the knowledge points, difficulty, or the number of questions corresponding to the difficulty. The electronic system of the embodiments of the disclosure has at least one of the following advantages. The electronic system may generate the test paper based on the generative adversarial network module, saving the user a significant amount of time. The user only need to operate on the GUI provided by the electronic system to generate the required test paper. The electronic system may generate suitable test paper based on the user requirement such as the number of questions, knowledge points, difficulty, types of question, or answering time. If the user is not satisfied with the distribution relationship between the questions and the knowledge points in the generated test paper, the user may provide feedback on the user preference to the generative adversarial network module, and instruct the generative adversarial network module to generate a new test paper based on the user preference. The electronic system may also retrain the discriminator of the generative adversarial network module according to the user preference, thereby further updating the generator of the generative adversarial network module. As a result, the test paper generated by the electronic system in the future better meets the user requirement.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. An electronic system for generating a test paper, comprising:
an electronic device, comprising:
an input device;
a display device, configured to provide a graphical user interface;
a first storage medium, configured to store a test paper generation program; and
a first processing device, electrically coupled to the first storage medium, the input device, and the display device respectively, wherein the first processing device is configured to execute the test paper generation program, the first processing device is configured to obtain a user requirement according to a first user operation on the graphical user interface through the input device, the first processing device is configured to obtain the test paper according to the user requirement by executing the test paper generation program, and the display device is configured to display a preview of the test paper.

2. The electronic system according to claim 1, wherein the user requirement comprises at least one of a number of questions, at least one knowledge point, difficulty, types of question, or answering time.

3. The electronic system according to claim 1, wherein the first storage medium is configured to store a generative adversarial network module, and the generative adversarial network module is configured to generate the test paper.

4. The electronic system according to claim 2, wherein the graphical user interface is configured to provide a plurality of options, the first processing device is configured to select the at least one knowledge point from the plurality of options according to the first user operation.

5. The electronic system according to claim 2, wherein the graphical user interface provides a slider, and the first processing device is configured to obtain the number of questions, the difficulty, or the types of question according to the first user operation on the slider.

6. The electronic system according to claim 3, wherein the input device is configured to receive a user command, the first processing device is configured to determine whether the test paper is usable according to the user command, and in response to determining that the test paper is not usable, the input device is configured to receive a second user operation on the graphical user interface to obtain a user preference, and
the first processing device is configured to generate a new test paper by the generative adversarial network module according to the user preference.

7. The electronic system according to claim 6, wherein the user preference comprises at least one of at least one knowledge point, a number of questions corresponding to the at least one knowledge point, difficulty, and a number of questions corresponding to the difficulty.

8. The electronic system according to claim 6, wherein the first processing device is configured to provide a bar chart through the graphical user interface, and the first processing device is configured to obtain at least one knowledge point and a number of questions corresponding to the at least one knowledge point according to the second user operation on the bar chart.

9. The electronic system according to claim 6, wherein the first processing device is configured to provide a pie chart through the graphical user interface, and the first processing device is configured to obtain difficulty and a number of questions corresponding to the difficulty according to the second user operation on the pie chart.

10. The electronic system according to claim 1, wherein the first processing device is configured to receive questions, provide a plurality of options corresponding to the questions through the graphical user interface, and receive a third user operation on the graphical user interface through the input device, and the first processing device is configured to select a label from the plurality of options according to the third user operation, and
the first processing device is configured to generate training data according to the questions and the label.

11. The electronic system according to claim 1, wherein the first processing device is configured to receive a file comprising a plurality of questions, and provide a plurality of options corresponding to the file through the graphical user interface, receive a third user operation corresponding to the graphical user interface through the input device, and the first processing device is configured to select a label from the plurality of options according to the third user operation, and
the first processing device is configured to generate a plurality of training data according to the plurality of questions and the label.

12. The electronic system according to claim 1, further comprising a cloud server, the cloud server being communicatively connected to the electronic device through a network, and the cloud server further comprising a second processing device and a second storage medium.

13. The electronic system according to claim 12, further comprising the user requirement comprising at least one of a number of questions, at least one knowledge point, difficulty, types of question, or answering time.

14. The electronic system according to claim 12, wherein the second storage medium is configured to store a generative adversarial network module, and the generative adversarial network module is configured to generate the test paper.

15. The electronic system according to claim 13, wherein the graphical user interface is configured to provide a plurality of options, and the second processing device is configured to select the at least one knowledge point from the plurality of options according to the first user operation.

16. The electronic system according to claim 13, wherein the graphical user interface provides a slider, and the second processing device is configured to obtain the number of questions, the difficulty, or the types of question according to the first user operation on the slider.

17. The electronic system according to claim 14, wherein the input device is configured to receive a user command, the second processing device is configured to determine whether the test paper is usable according to the user command, and in response to determining that the test paper is not usable, the input device is configured to receive a second user operation on the graphical user interface to obtain a user preference, and
the second processing device is configured to generate a new test paper by the generative adversarial network module according to the user preference.

18. The electronic system according to claim 17, wherein the user preference comprises at least one of at least one knowledge point, a number of questions corresponding to the at least one knowledge point, difficulty, or a number of questions corresponding to the difficulty.

19. The electronic system according to claim 17, wherein the second processing device is configured to provide a bar chart through the graphical user interface, and the second processing device is configured to obtain at least one knowledge point and a number of questions corresponding to the at least one knowledge point according to the second user operation on the bar chart.

20. The electronic system according to claim 17, wherein the second processing device is configured to provide a pie chart through the graphical user interface, and the second processing device is configured to obtain difficulty and a number of questions corresponding to the difficulty according to the second user operation on the pie chart.

21. The electronic system according to claim 12, wherein the second processing device is configured to receive questions, and provide a plurality of options corresponding to the questions through the graphical user interface, and receive a third user operation on the graphical user interface through the input device, and the second processing device is configured to select a label from the plurality of options according to the third user operation, and
the second processing device is configured to generate training data according to the questions and the label.

22. The electronic system according to claim 12, wherein the second processing device is configured to receive a file comprising a plurality of questions, provide a plurality of options corresponding to the file through the graphical user interface, and receive a third user operation corresponding to the graphical user interface through the input device, and the second processing device is configured to select a label from the plurality of options according to the third user operation, and
the second processing device is configured to generate a plurality of training data according to the plurality of questions and the label.

23. A method for generating a test paper, applicable to an electronic system, the electronic system comprising: an electronic device, the electronic device comprising an input device, a display device, a first storage medium, and a first processing device, and the method comprising:
executing a test paper generation program by the first processing device;
displaying a graphical user interface by the display device;
obtaining a user requirement according to a first user operation on the graphical user interface by the input device;
obtaining the test paper according to the user requirement by the first processing device; and
displaying a preview of the test paper by the display device.
